(19) United States
(12) Patent Application Publication
(10) Pub. No.: US 2021/0390537 A1
(43) Pub. Date: Dec. 16, 2021

(54) AUTHENTICATION AND PERSONAL DATA SHARING FOR PARTNER SERVICES USING OUT-OF-BAND OPTICAL MARK RECOGNITION

(71) Applicant: WINKK, INC, Menlo Park, CA (US)

(72) Inventors: Renata Budko, Los Altos, CA (US); Robert O. Keith, JR., San Jose, CA (US); Asim Abdullah, Atherton, CA (US)

(73) Assignee: Winkk, Inc.

(21) Appl. No.: 17/459,649

(22) Filed: Aug. 27, 2021

Related U.S. Application Data
(63) Continuation-in-part of application No. 17/314,900, filed on May 7, 2021.
Application No. 17/314,900 is a continuation of application No. 15/721,899, filed on Sep. 30, 2017, now Pat. No. 11,030,618.
(60) Provisional application No. 62/402,728, filed on Sep. 30, 2016.

(51) Int. Cl. G06Q 20/38; H04L 29/06; G06K 7/14; G06Q 20/40

(52) U.S. Cl. CPC G06Q 20/38215; H04L 63/0838; G06K 7/1417; G06Q 20/388; G06Q 20/385; G06Q 20/3823; G06Q 20/4014

(57) ABSTRACT

Disclosed are methods and apparatuses for creating a verified mutually authenticated transaction between a service provider and an on-line identity for a physical client person. A dynamic optical mark may be displayed on a device screen where the physical client person is using a web service. The dynamic optical mark may be recognized via scanning the dynamic optical mark by a personal mobile device equipped with a camera. The verified mutually authenticated transaction between the service provider and the on-line identity for the physical client person may be used for sharing personal data of the physical client person by using out-of-band optical mark recognition of the dynamic optical mark. The verified mutually authenticated transaction may be initiated with a time-limited one-time password comprising a sequence of numbers encoded in the dynamic optical mark.

### CROSS-REFERENCE TO RELATED APPLICATIONS

This application is a continuation-in-part application of co-pending U.S. patent application Ser. No. 17/314,900, filed May 7, 2021, titled “AUTHENTICATION AND PERSONAL DATA SHARING FOR PARTNER SERVICES USING OUT-OF-BAND OPTICAL MARK RECOGNITION,” which is a continuation application of U.S. patent application Ser. No. 15/721,899, filed Sep. 30, 2017, titled “AUTHENTICATION AND PERSONAL DATA SHARING FOR PARTNER SERVICES USING OUT-OF-BAND OPTICAL MARK RECOGNITION,” which claims benefit of U.S. Provisional Patent Application No. 62/402,728, filed Sep. 30, 2016, which are all hereby incorporated by reference in their entireties for all purposes.

### BACKGROUND OF THE DISCLOSURE

Authentication is an important aspect of on-line communication between various parties, such as service providers and individual users. In order to use a web service offered by a service provider, a user may need to confirm his identity to the service provider. The service provider may implement an authentication service locally or use an external identity provider to confirm the user's identity. When using an external identity provider, the service provider may request the identity confirmation via a standard API and may receive a verified user identity as a response. When using the web service, the user may share personal data with the service provider. A common way for implementing authentication for both local implementations and external identify provider services is based on the use of a username and a password as authentication credentials. Password-based authentication, however, can be problematic. Usernames or passwords can be forgotten, stolen, or unintentionally exposed.

### SUMMARY OF THE DISCLOSURE

This disclosure provides methods and apparatuses for creating a verified mutually authenticated transaction between a service provider and an on-line identity for a physical client person. A dynamic optical mark may be displayed on a device screen where the physical client person is using a web service. The dynamic optical mark may be recognized via scanning the dynamic optical mark by a personal mobile device equipped with a camera.

The verified mutually authenticated transaction between the service provider and the on-line identity for the physical client person may be used for sharing personal data of the physical client person by using out-of-band optical mark recognition of the dynamic optical mark. The verified mutually authenticated transaction may be initiated with a time-limited onetime password comprising a sequence of numbers encoded in the dynamic optical mark.

The on-line identity for the physical client person may be authenticated to the web service by signing a transaction completion request with a private key and a corresponding public key stored within the web service may be used for verification. The on-line identity may be verified by personal biometry. The private key may be stored at a hardware encrypted storage (TPM) of the personal mobile device.

An authorization assertion may be constructed and passed to the service provider. The authorization assertion may be in a form of a 0Auth2 token, SAML token, RP token or another provider supported technology.

### BRIEF DESCRIPTION OF THE DRAWINGS

FIG. 1 illustrates exemplary processes for user registration or user authorization.

FIG. 2 illustrates an exemplary process for user authorization at a partner web service.

FIG. 3 illustrates a diagram of a two-way communication using an optical mark according to some embodiments.

FIG. 4 illustrates a flowchart of a method of performing a two-way communication using an optical mark according to some embodiments.

### DETAILED DESCRIPTION

In the following description of examples, reference is made to the accompanying drawings which form a part hereof, and in which it is shown by way of illustration specific examples that can be practiced. It is to be understood that other examples are can be used and structural changes can be made without departing from the scope of the disclosed examples.

According to one aspect, a cloud-based service, or cloud service, is described which implements means to create a verified mutually authenticated transaction between a service provider and an on-line identity securely tied to a physical person with a custom mandatory security step integrated. In one example, the custom step involves displaying of a specially formed dynamic optical mark on the device where client is using web service (e.g., authorized email), and recognition of this mark via scanning it by client personal smartphone.

The client personal smartphone may hold a personal client certificate created during enrollment procedure. The personal smartphone may manage client authorization, provide full control of the stored personal data, manage the access to personal data from thirdparties. Client can revoke the third-party access at any time. On the other hand, the communication between client personal smartphone and the cloud service (implemented via, e.g., an API layer and a database) may be encrypted by personal client certificate and can be performed by public networks without security flaw too.

Instead of directly providing authorization credentials, a client may use his/her personal smartphone as identity provider after mark recognition. User may specify the part of the personal data that he/she wants to share with the third-party. No sensitive data (including client credentials, client profile list, etc.) other than explicitly allowed by user for this third-party may be transferred through the computer and network used for accessing of third-party service. No direct communication may be performed between the computer and client smartphone apart from optical mark recognition. Sensitive data management may be leveraged to the client smartphone.

Client may have a number of personal data sets (profiles) stored in the single account. When a personal data is requested by the third-party, the client may have the ability to choose the profile to be shared.

Additional security level can be enabled at the smartphone by using available built-in capabilities such as device-wide password protected lock, retina scanning, fingerprint scanning Moreover, additional security level can be enabled for different profiles separately.

In one example, the solution uniquely features ability to initiate each transaction with a sequence of numbers encoded in a proprietary dynamic optical code (see, e.g., U.S. Ser. No. 62/248,605, entitled “Palette-Based Optical Recognition Code Generators and Decoders,” the entire content of which is incorporated by reference herein). These numbers may represent the time-limited one-time password (TOTP) represented in a form of a series of static optical marks. Only third-parties who are authenticated to the service can initiate transactions. Dynamic nature of the optical code may provide sufficient encoding depth and channel robustness for the high level of password security.

To complete the transaction, the code may be read through a mobile phone camera. The optical nature of the code recognition may create an out-of-band transaction verification channel air-gapped from the network over which the digital service is provided.

Client's on-line identity may authenticate to the service by signing its transaction completion request with its private key stored in the phone's hardware encrypted storage (TPM). Corresponding public key needed for verification may be stored within the service.

Once the client is authenticated, authorization assertion, which could take a form of a 0Auth2 token, SAML token, RP token or another provider supported technology, may be passed to the third-party, creating a closed-loop process.

In case the mobile phone is compromised, a new set of private/public key pair may be issued. A key pair may correspond to the mobile device, or can be created individually for each of the on-line identities (profiles) registered for the physical person.

Transactions that require lower level of security can implement the protocol partially. Transactions that require multiple independent providers can also be supported.

The cloud service can be implemented via, e.g., API layer(s) and database(s) that are run on server(s), such as Linux server(s). The client personal smartphone or mobile phone may be examples of a personal mobile device. The functionalities of each computing device mentioned in this disclosure (e.g., server, personal mobile device, computer) can be performed by suitable logic circuitry in or for that computing device. For example, suitable logic circuitry may include processor(s) that, when executing instruction implemented in software program(s) stored in processor-readable storage medium(s) (e.g., memory) in or for that computing device, performs that computing device's functionalities. As another example, suitable logic circuitry may include hardware logic circuitry, such as a programmable logic device or an applicationspecific integrated circuit, implementing logic designs that provide that computing device's functionalities. As yet another example, suitable logic circuitry for that computing device may include an implementation that combines both processor(s) running software and hardware logic circuitry.

The following workflows describe exemplary processes of partner registration, user registration, user authorization on the example of 0Auth2 protocol used for data sharing.

Third-Party Partner Registration

To get personal information about particular client, third-party partner may need to be registered providing administrator email, service name, service base URL, URL for 0Auth2 redirect required access level and arbitrary secret key. These registration data may be stored in the database 160.

Third-party administrator may provide additional information on how to verify the owner of the domain and payment information.

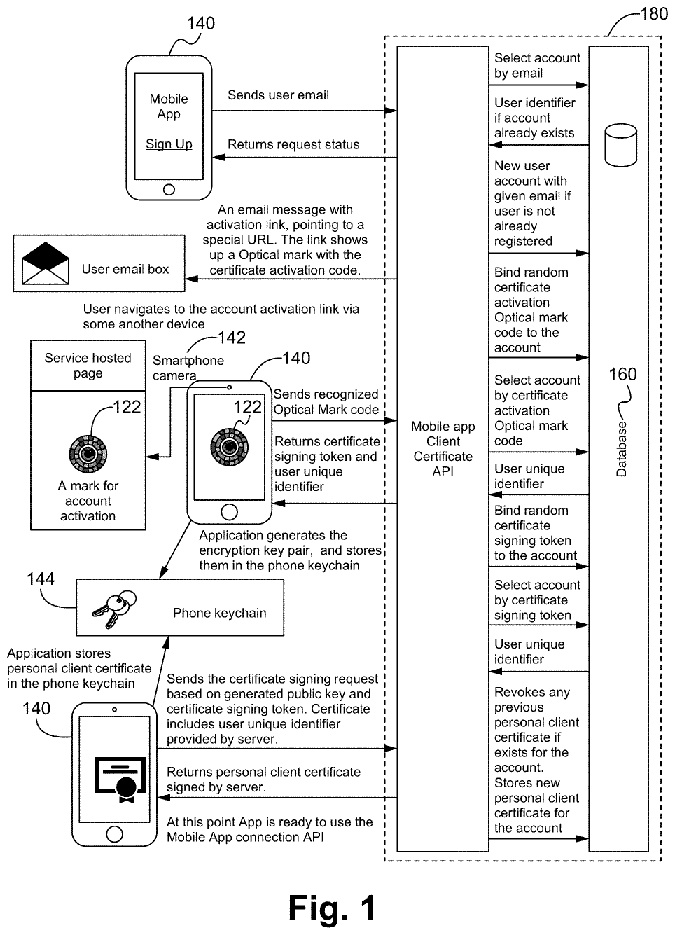

FIG. 1 illustrates an exemplary process for user registration at mobile application.

Workflow for User Registration at Mobile Application

User may install the application 120 at his smartphone 140 and start it.

A Sign Up view of application 120 may be displayed.

User may navigate to the Sign Up screen and follow the sign up procedure providing his email.

Application 120 may send the given email to the cloud service 180 over TLS connection using temporary asymmetric RSA key pair for this communication. TLS connection can also be known as SSL connection.

An account record may be created for the user, having stored user email. An activation link may be sent to user email.

A message may be shown to the user informing him that the enrollment procedure is pending and he should check email. A scanner view of the application 120 may be displayed with all UI controls related to user profile disabled.

User may navigate to the activation link on another computer. A special dynamic optical mark 122 for enrollment procedure may be displayed. Optical mark 122 may encode registration session identifier.

User may scan the given optical mark 122 by pointing smartphone camera 142 to the optical mark 122 having application 120 in the foreground.

Application 120 may send the scanned code to the cloud service 180 over TLS (or SSL) connection using temporary asymmetric RSA key pair for this communication.

If recognized code matches to stored registration session identifier then cloud service 180 may return the unique user identifier and certificate signing token to the application 120.

Application 120 may generate a new personal asymmetric RSA key pair and store the private key at the smartphone 140 in protected storage space 144.

X.509 certificate signing request may be created using the personal key pair and given user identifier.

Application 120 may send the X.509 certificate signing request and certificate signing token to the cloud service 180 over TLS (or SSL) connection using temporary asymmetric RSA key pair for this communication.

Cloud service 180 may match user identifier with X.509 certificate signing request and certificate signing token, sign the X.509 certificate and return signed personal X.509 certificate to the application 120.

Application 120 may store the personal X.509 certificate at the smartphone 140 in protected storage space 144 and enable UI controls related to user profile.

User may create and fill in at least one profile in the application 120.

Application 120 may send profile data to the cloud service 180 over TLS (or SSL) connection using personal X.509 certificate.

Cloud service 180 may identify user by personal X.509 certificate and store the profile information.

Application 120 may be ready to scan optical marks to perform user authorization at third-parties.

Workflow for User Certification Invalidation

Personal user certificate invalidation may be performed at the following circumstances.
a. Administrator manually revokes the certificate for particular user via Administrative Tool.
b. User installs the application 120 to another device and activates a new personal certificate, the previous one becomes revoked.
c. Personal user certificate is expired.

When mobile application 120 tries to perform any request over TLS (or SSL) connection using revoked/expired personal X.509 certificate, the cloud service 180 may return special error code denoting the using certificate is invalid and should be deleted.

Application 120 may check if the server certificate matches the one stored at the application 120, removes certificate and RSA key pair from the keychain and show Sign Up view.

User may have to follow the “Workflow for user authorization at the application using another device (or in the case of personal X.509 certificate revocation/expiration)” below.

FIG. 1 also illustrates an exemplary process for user authorization at the application using another device (or in the case of personal X.509 certificate revocation/expiration)

Workflow for User Authorization at the Application Using Another Device (or in the Case of Personal X.509 Certificate Revocation/Expiration)

User may install the application 120 at a new smartphone 140 and start it, or User may start the application 120 having invalid (e.g., revoked or expired) personal X.509 certificate.

A Sign Up view of the application 120 may be displayed.

User may navigate to the Sign Up screen and may follow the sign up procedure providing his email.

Application 120 may send the given email to the cloud service 180 over TLS (or SSL) connection using temporary asymmetric RSA key pair for this communication.

Cloud service 180 may find user account by given email. An activation link may be sent to user email.

A message may be shown to the user informing him that the enrollment procedure is pending and he should check email. A scanner view of the application 120 may be displayed with all UI controls related to user profile disabled.

User may navigate to the activation link on another computer. A special dynamic optical mark 122 for enrollment procedure may be displayed.

User may scan the given optical mark 122 by pointing smartphone camera 142 to the optical mark 122 having application 120 in the foreground.

Application 120 may send the scanned code to the cloud service 180 over TLS (or SSL) connection using temporary asymmetric RSA key pair for this communication.

Cloud service 180 may return the unique user identifier and certificate signing token to the application 120.

Application 120 may generate a new personal asymmetric RSA key pair and store the private key at the smartphone 140 in protected storage space 144.

X.509 certificate signing request may be created using the personal key pair and given user identifier.

Application 120 may send the X.509 certificate signing request and certificate signing token to the cloud service 180 over TLS (or SSL) connection using temporary asymmetric RSA key pair for this communication.

Cloud service 180 may match user identifier with X.509 certificate signing request and certificate signing token, sign the X.509 certificate and return signed personal X.509 certificate to the application 120.

Application 120 may store the personal X.509 certificate at the smartphone 140 in protected storage space 144 and enable UI controls related to user profile.

User may create and fill in at least one profile in the application 120.

Application 120 sends profile data to the cloud service 180 over TLS (or SSL) connection using personal X.509 certificate.

Cloud service 180 may identify user by personal X.509 certificate and store the profile information.

Application 120 may be ready to scan optical marks to perform user authorization at third-parties.

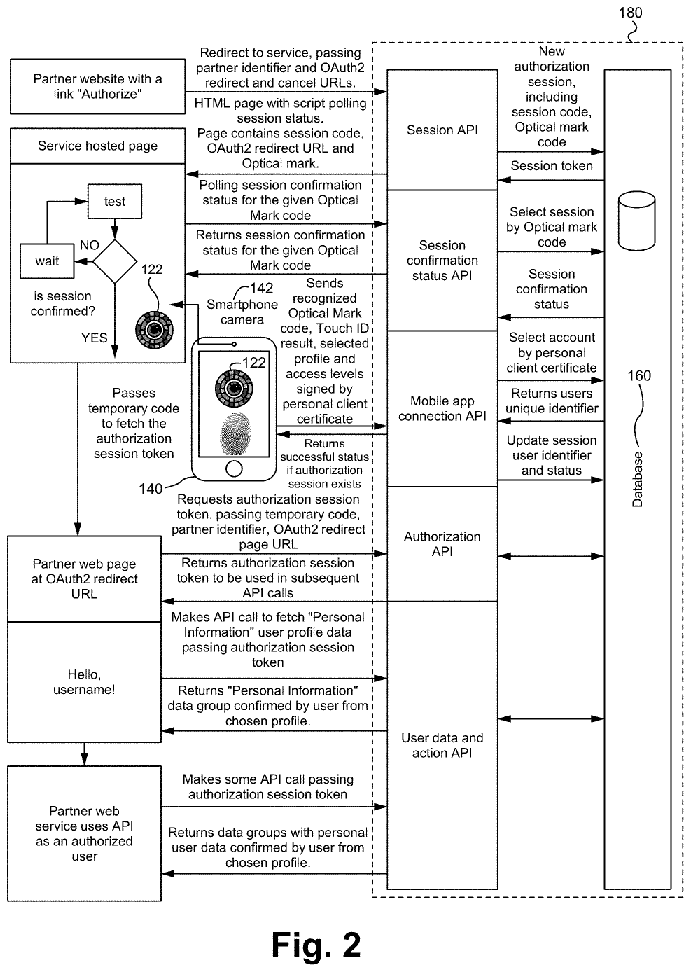

FIG. 2 illustrates an exemplary process for user authorization at a partner web service.

Workflow for User Authorization at a Partner Web Service

User may click at the special link at the partner web service.

Third-party may redirect user browser to a special web page for custom authorization.

A new authorization session may be created in the cloud service 180. A random session code, random dynamic optical mark code, access token, and one-time 0Auth2 code may be generated and stored in the authorization session record.

The custom authorization page may display special dynamic optical mark 122 to user and display information on which data will be available to the partner. A polling may be performed to check if mark 122 is already recognized.

User may start the application 120 and direct smartphone camera 142 to the dynamic optical mark 122 displayed at the page.

Application 120 may recognize the dynamic optical mark 122 and send its code over TLS (or SSL) connection using personal X.509 certificate.

Cloud service 180 may identify source user by personal X.509 certificate and associate user identifier with the authorization session.

If user has already authorized with this partner:
Cloud service 180 may use the selected profile and access levels from the previous authorization session at this partner.

If user has not already authorized with this partner:
Cloud service 180 may return “profile” state to the application 120.
   Application 120 may display the profile choosing view with profile list and the access level controls.
User may select the profile he wants to be used by this partner. Before actual authorization, the user may, if he deems it fit, adjust the access levels.
Application 120 may send the selected profile identifier, access levels over TLS (or SSL) connection using personal X.509 certificate.
Cloud service 180 may identify source user by personal X.509 certificate and binds the profile selection and access levels to the authorization session.

If the selected profile and access levels require multi-factor procedure:
Cloud service 180 may return “multifactor” state to the application 120. Application 120 may display security screen with additional verification procedure implemented (for example, fingerprint scan).
User may go through the additional verification procedure.
Application 120 may send the additional verification result over TLS (or SSL) connection using personal X.509 certificate.
Cloud service 180 may identify source user by personal X.509 certificate and the authorization session and allow the process to continue.

Cloud service 180 may return “finish” state to the application 120.

Application 120 may return to the main scanner view.

Custom authorization page may redirect user browser back to the partner web service (HTTPS back redirect URL is mandatory) with the one-time 0Auth2 code in the GET parameter.

Partner web service may make a request to cloud service 180 via TLS (or SSL) connection providing partner web service identifier, given one-time 0Auth2 code and secret partner key.

Cloud service 180 may search the given one-time 0Auth2 code and returns the stored authorization session access token to the partner if match and the state of the authorization session is active.

Partner web service may now have an access token which may enable it to make requests to the cloud service 180.

Partner web service may make a request to cloud service 180 using given access token to fetch user unique identifier, first and last name and any other required private information. Cloud service 180 may return requested data if the state of the authorization session is active.

User may see his name at the partner website and can act as an authorized user.

Partner website may contain a link that makes user to logout. This link may pass the session code for the authorization session to be invalidated in the cloud service 180. Alternatively, user can break the authorization session at the partner web service at any time using “Remove Application” feature in the mobile application 120.

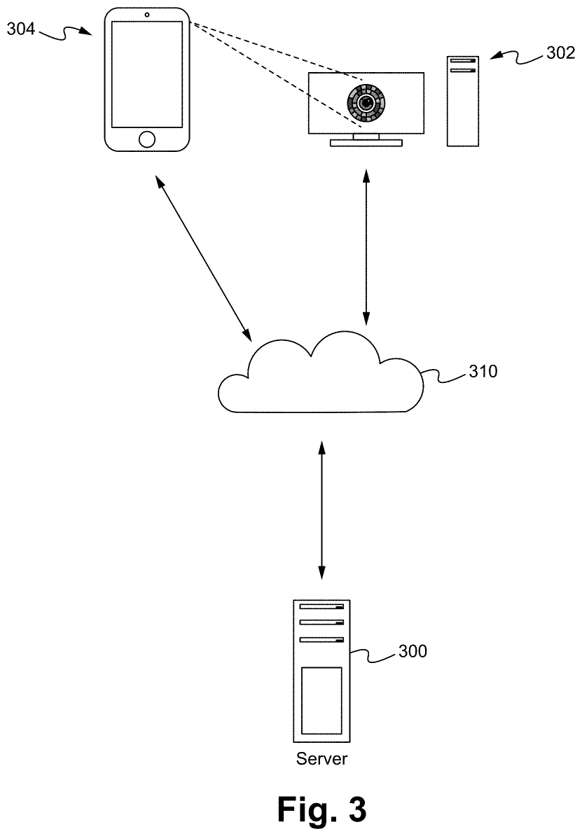

FIG. 3 illustrates a diagram of a two-way communication using an optical mark according to some embodiments. A server 300 generates an optical mark. As described herein, the optical mark is a dynamic mark that continuously changes. In some embodiments, the optical mark is streamed such that it continuously changes. For example, every n seconds (e.g., 1, 2, or 5 seconds) or fractions of a second, a new optical mark is displayed. Unlike a dynamic mark that changes each time a web page or application is open/refreshed, the optical mark described herein is continuously streamed such that it is continuously changing without a user refreshing a page/application. In some embodiments, the optical mark includes a continuous stream of frames (e.g., similar to a video) which continuously change and are displayed on the screen of a device. Additionally, the dynamic/streaming optical mark includes at least two concentric circles. The dynamic optical mark includes different colors (e.g., 3 different colors) within a calibration region within the concentric circles. A portion of the optical mark within the concentric circles includes segments where each segment includes one color of the different colors. The portion based on the three different colors is encoded including associating each color with an optical code. The optical mark is oriented by positioning a registration mark relative to the portion.

The generated optical mark is sent to a computing device 302 where the optical mark is displayed. For example, the optical mark is displayed on a computing device 302 such as a mobile phone, laptop or personal computer.

A user device 304 (or other device) recognizes the optical mark displayed on the device screen of the computing device 302. For example, a camera of a mobile device is used to scan the optical mark being displayed on a device screen. The optical mark is detected using the registration mark and the calibration region by identifying and assigning values to the plurality of segments of the segmented portion and decoding the optical code based on the assigned values. In some embodiments, scanning the optical mark occurs of a period of time (e.g., 1, 2 or 5 seconds, or a fraction of seconds) since the scan is of multiple streamed frames. For example, scanning the optical mark is not simply a single screenshot of the optical mark; rather, it is a scan of multiple frames of the optical mark over a period of time. Thus, in some embodiments, multiple frames with different appearances of the mark are acquired/captured. The user device 304 communicates the acquired optical mark (and/or other information) to the server 300 which authenticates an on-line identity for a user based on the optical code of the optical mark and based on an on-line identity of the user. Although a user device 304 is discussed as recognizing the optical mark, any computing device is able to recognize the optical mark.

In some embodiments, the streaming optical mark changes based on data received from the user device 304. For example, if the server 300 suspects a possible hacking situation or malware based on the data received from the user device 304 (e.g., using machine learning a similar type of hack has previously been detected), the optical mark being streamed is able to be modified so that the hack is not able to gain access. Furthering the example, if it suspected that a hacker, virus or malware has determined a sequence in the streaming optical code/mark, the streaming optical code/mark is able to be changed (e.g., use a different random seed to trigger the streaming frames or otherwise change the sequence of streaming frames).

The server 300 authorizes the user to access a web service of a web service provider in response to the authentication of the on-line identity for the user.

The user device 304 displays on the device screen a visual indication of the authorization of the computing device 302 to access the web service of the web service provider.

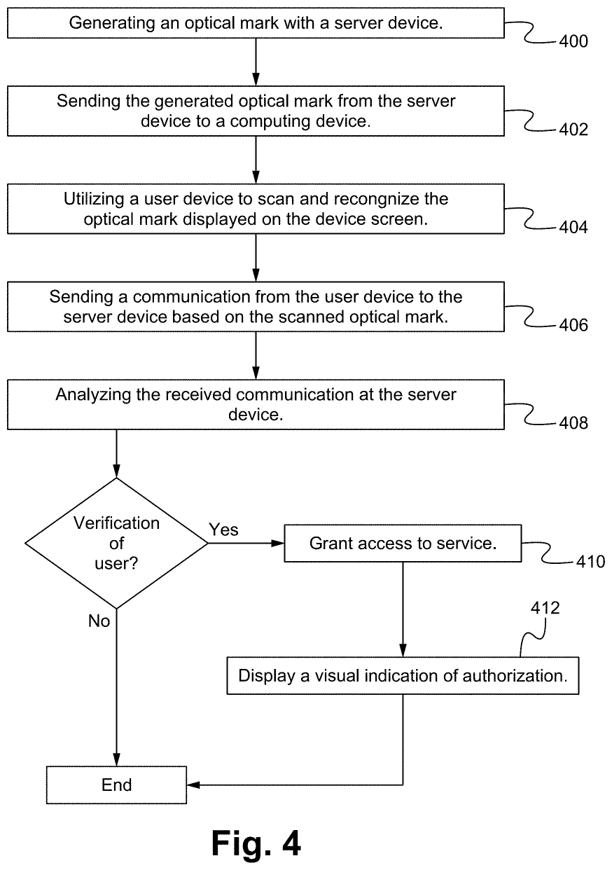

FIG. 4 illustrates a flowchart of a method of performing a two-way communication using an optical mark according to some embodiments. In the step 400, a server device generates an optical mark. The optical mark is a dynamic/streaming optical mark that includes at least two concentric circles (or another shape). The optical mark includes different colors (e.g., 3 different colors) within a calibration region within the concentric circles. A portion of the optical mark within the concentric circles includes segments where each segment includes one color of the different colors. The portion based on the three different colors is encoded including associating each color with an optical code. The optical mark is oriented by positioning a registration mark relative to the portion.

In the step 402, the generated optical mark is sent (e.g., streamed) from the server device to a computing device where the optical mark is displayed. For example, the optical mark is displayed on a screen of the computing device such as a mobile phone, laptop or personal computer. Since the optical mark is streamed to the computing device, the optical mark is able to be continuously changing. For example, every n seconds (e.g., 1, 2, or 5 seconds) or fractions of a second, a new optical mark (or frame of the optical mark) is displayed. Streaming is able to include sending a stream of frames, where each frame is a different optical mark/code. In some embodiments, the frames are able to change rapidly as the frames of a video change rapidly (e.g., 24 or 60 frames per second). Additionally, the order of the frames is able to be modified dynamically. For example, if a stream of frames is sent and displayed, but the server detects an anomaly from the user device or elsewhere, then the server is able to change the stream of frames being sent in the stream. In one example, the stream of frames is randomized, but if the randomization is hacked by a malicious actor/device, then a different randomization is able to be triggered to change the stream of frames.

In the step 404, a user utilizes a user device (e.g., mobile device or another computing device) to scan and recognize the optical mark displayed on the device screen of the computing device. For example, a camera of a mobile device is used to scan the optical mark being displayed on a device screen. The optical mark is detected using the registration mark and the calibration region by identifying and assigning values to the plurality of segments of the segmented portion and decoding the optical code based on the assigned values. Scanning the optical mark is able to be over a period of time (e.g., scanning the optical mark for 3 seconds or fractions of a second) such that multiple frames are scanned and analyzed.

In the step 406, the user device sends a communication to the server device based on the scanned optical mark. In some embodiments, the scanned/captured optical mark is sent by the user device to the server device which then verifies whether the scanned optical mark is valid. In addition to analyzing each frame of the optical mark, the sequence of the frames is analyzed. For example, the optical mark is displayed with frame 1, followed by frame 2 and then frame 3, and so on, and the user device acquires frames 1, 2 and 3 which are sent to the server device. When a comparison of the frames occurs at the server device, if the order of the frames is not frame 1, 2, and 3 (e.g., a hacker sends frame 3, 1 and then 2), then a match is not confirmed, and authentication is denied. In some embodiments, in addition to the scanned optical mark, user identification information is sent to the server device. For example, in addition to the scanned optical mark, a username is also sent to the server device. In some embodiments, the mobile device performs an optical mark analysis, and the result of that analysis is sent to the server device for verification. In some embodiments, the communication is encrypted.

In the step 408, the server device analyzes the received communication. Regardless of the embodiment, the server device performs an analysis of the received communication to determine whether the received communication matches/authenticates the sent optical mark. For example, the server is able to store any data related to the sent information (e.g., streamed optical mark) and then compare the stored data with the information received from the user device. Furthering the example, the server device compares the scanned frames of the stream received from the user device with the stored frames of the stream. The data is able to be stored in any manner such as storing optical codes which correspond to each frame which are easily compared with the scanned/received data using a look up table or any other data comparison.

If the analysis verifies that the received information matches/authenticates the sent optical mark, then the server device provides access to the user device (e.g., enables the user device to access a social media account or a bank account), in the step 410. In other words, server device authorizes the user to access a web service of a web service provider in response to the authentication of the on-line identity for the user (e.g., by sending an authentication code to the web service provider). In some embodiments, the server device changes the optical mark based on the received communication, and the user continues scanning the optical mark stream.

In the step 412, the user device displays on the device screen a visual indication of the authorization of the user device and/or the computing device to access the web service of the web service provider.

In some embodiments, fewer or additional steps are implemented. For example, the optical mark is generated in response to a user requesting access to a service (e.g., trying to log in to Facebook). In some embodiments, the order of the steps is modified.

It should be noted that the practice of the present disclosure is not limited to the above-described examples. Those of ordinary skill in the art may perform modification or variation in accordance with the foregoing description, and all such modifications and variations should fall into the scope of the appended claims of the present disclosure.

What is claimed is:

1. A method comprising:
generating a streaming optical mark with a server;
streaming the streaming optical mark to a first computing device;
receiving, at the server, a communication from a second computing device related to the streaming optical mark;
analyzing the communication related to the streaming optical mark;
providing access to a service based on the analysis of the communication related to the streaming optical mark.

2. The method of claim 1 wherein the streaming optical mark includes a plurality of frames, wherein the streaming optical mark includes at least two concentric circles, at least three different colors within a calibration region within the concentric circles, a portion of the optical mark within the concentric circles includes segments where each segment includes one color of the three different colors, the portion based on the three different colors is encoded including associating each color with an optical code.

3. The method of claim 2 wherein the streaming optical mark is oriented by positioning a registration mark relative to the portion.

4. The method of claim 1 wherein the second computing device is configured to scan and capture the streaming optical mark over a period of time.

5. The method of claim 1 wherein the communication includes the streaming optical mark.

6. The method of claim 1 wherein the communication includes user identification information.

7. The method of claim 1 wherein analyzing the streaming optical mark includes determining if the received communication matches a stored streaming optical mark on the server.

8. The method of claim 1 further comprising changing the streaming optical mark based on data received from the second computing device.

9. An apparatus comprising:
a memory configured for storing an application, the application configured for:
generating a streaming optical mark;
streaming the streaming optical mark to a first computing device;
receiving a communication from a second computing device related to the streaming optical mark;
analyzing the communication related to the streaming optical mark; and
providing access to a service based on the analysis of the communication related to the streaming optical mark; and
a processor for processing the application.

10. The apparatus of claim 9 wherein the streaming optical mark includes a plurality of frames, wherein the streaming optical mark includes at least two concentric circles, at least three different colors within a calibration region within the concentric circles, a portion of the optical mark within the concentric circles includes segments where each segment includes one color of the three different colors, the portion based on the three different colors is encoded including associating each color with an optical code.

11. The apparatus of claim 10 wherein the streaming optical mark is oriented by positioning a registration mark relative to the portion.

12. The apparatus of claim 9 wherein the second computing device is configured to scan and capture the streaming optical mark over a period of time.

13. The apparatus of claim 9 wherein the communication includes the streaming optical mark.

14. The apparatus of claim 9 wherein the communication includes user identification information.

15. The apparatus of claim 9 wherein analyzing the streaming optical mark includes determining if the received communication matches a stored streaming optical mark on the apparatus.

16. The apparatus of claim 9 wherein the application is further for changing the streaming optical mark based on data received from the second computing device.

17. A system comprising:
a first computing device configured for displaying a streaming optical mark; and
a second computing device configured for:
scanning the streaming optical mark displayed on the first computing device; and
a server device configured for:
generating the streaming optical mark;
streaming the streaming optical mark to the first computing device;
receiving a communication based on the scanned optical mark;
analyzing the communication related to the streaming optical mark received from the second computing device; and
providing access to a service based on the analysis of the communication related to the streaming optical mark.

18. The system of claim 17 wherein the streaming optical mark includes a plurality of frames, wherein the streaming optical mark includes at least two concentric circles, at least three different colors within a calibration region within the concentric circles, a portion of the optical mark within the concentric circles includes segments where each segment includes one color of the three different colors, the portion based on the three different colors is encoded including associating each color with an optical code.

19. The system of claim 18 wherein the streaming optical mark is oriented by positioning a registration mark relative to the portion.

20. The system of claim 17 wherein the second computing device is configured to scan and capture the streaming optical mark over a period of time.

21. The system of claim 17 wherein the communication includes the streaming optical mark.

22. The system of claim 17 wherein the communication includes user identification information.

23. The system of claim 17 wherein analyzing the streaming optical mark includes determining if the received communication matches a stored streaming optical mark on the server device.

24. The system of claim 17 wherein the server device is configured changing the streaming optical mark based on data received from the second computing device.
